(19) United States
(12) Patent Application Publication
(10) Pub. No.: US 2012/0274472 A1
(43) Pub. Date: Nov. 1, 2012

(54) POWER SUPPY SYSTEM

(75) Inventor: MING-XIANG HU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/171,459

(22) Filed: Jun. 29, 2011

(30) Foreign Application Priority Data
Apr. 26, 2011 (CN) 201110104676.1

(51) Int. Cl. G08B 21/00; G06F 1/28

(52) U.S. Cl. 340/662; 713/340

(57) ABSTRACT

A power supply system includes a current detection module, an analog-to-digital converter, a control module and a display module. The current detection module detects current signals output from the power supply system and converts the current signal to voltage signal. The analog-to-digital converter converts the analog voltage signal to digital voltage signal. The control module receives the digital voltage signal output from the analog-to-digital converter and converts the digital voltage signal to digital current digital, and calculates the actual output power of the power supply system. The display module displays the actual output power of the power supply system. A method for displaying the power of a power supply system is also disclosed.

### BACKGROUND

1. Technical Field

The disclosure relates to a power supply system and a method for displaying the output power of the power supply system.

2. Discussion of Related Art

A power supply system is an important part of an electronic product, such as personal computer. For example, in a computer system, a power supply unit provides +3.3V, +/−5V, +/−12V, +5V_SB (stand by), for electrical loads such as central processing units (CPUs), hard disk drivers (HDDs) or random-access memory (RAM). Generally, a number of external devices, such as heat dissipation devices, or speakers are connected to the computer system. However, the power supply does not display the actual output power, therefore, the users cannot tell whether the actual output power is greater than the rated power or not. If the actual output power is greater than the rated power, and the users add more external devices, the power supply system may burn out or damaged.

Therefore, what is needed is a power supply system which can overcome the described limitations.

### BRIEF DESCRIPTION OF THE DRAWINGS

Many aspects of the disclosure can be better understood with reference to the following drawing. The components in the drawing are not necessarily drawn to scale, the emphasis instead being placed upon clearly illustrating the principles of the present power supply system. Moreover, in the drawing, like reference numerals designate corresponding parts throughout the whole view.

FIG. 1 is a block diagram of an exemplary embodiment of a power supply system.

FIG. 2 is a flowchart of an exemplary embodiment of a method for displaying output power of the power supply system of FIG. 1.

### DETAILED DESCRIPTION OF EMBODIMENTS

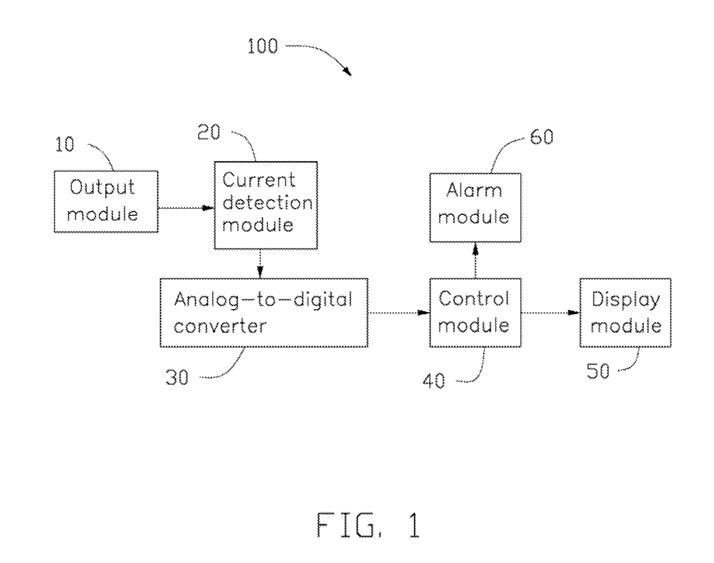

Referring to FIG. 1, an exemplary embodiment of a power supply system 100 for a computer is shown. The power supply system 100 includes an output module 10, a current detection module 20, an analog-to-digital converter (A/D converter) 30, a control module 40 and a display module 50.

The output module 10 includes a number of output terminals for providing rated voltages, such as +3.3V, +/−5V, +/−12V, +5V_SB (stand by), for electrical loads. Each of the output terminals of the output module 10 outputs a current signal.

The current detection module 20 is electrically connected to the output terminals of the output module 10. The current detection module 20 detects the current signals output from the output module 10, and converts the current signal to voltage signal.

The analog-to-digital converter 30 is electrically connected to an output of the current detection module 20. The analog-to-digital converter 30 is configured for converting the analog voltage signal to digital voltage signal.

The control module 40 is electrically connected to an output of the analog-to-digital converter 30. The control module 40 receives the digital voltage signal output from the analog-to-digital converter 30, and converts the digital voltage signal to digital current digital. The control module 40 calculates the actual output power of the power supply system 100 according to the rated voltages of the output module 10 and the digital current digital. The control module 40 stores a predetermined power value equal to or less than the rated power value of the power supply system 100. In the present embodiment, the control module 40 is electrically connected to a main body of the computer; therefore, the main body of the computer can adjust the predetermined power value. In the present embodiment, the predetermined power value is equal to the rated power of the power supply system. The control module 40 determines whether the actual output power is greater than the predetermined power value. If the actual output power is equal to or greater than the predetermined power value, the control module 40 outputs a warning signal. If the actual output power is less than the predetermined power value, the control module 40 does not output a warning signal.

The display module 50 is electrically connected to an output of the control module 40 for displaying the predetermined power value and the actual output power of the power supply system 100. In the present embodiment, the output module 10 of the power supply system 100 includes a number of output terminals. The display module 50 respectively displays the actual output power of the output terminals, the total actual output power of the output module 10, and the predetermined power value stored in the control module 40. The display module 50 can be selected from a seven-segment display, or a display screen.

In the present embodiment, the power supply system 100 further includes an alarm module 60. The alarm module 60 is electrically connected to an output of the control module 40 for receiving the warning signal output from the control module 40. In other words, when the actual output power of the power supply system 100 is equal to or greater than the predetermined power value, the alarm module 60 receives the warning signal and sounds an alarm.

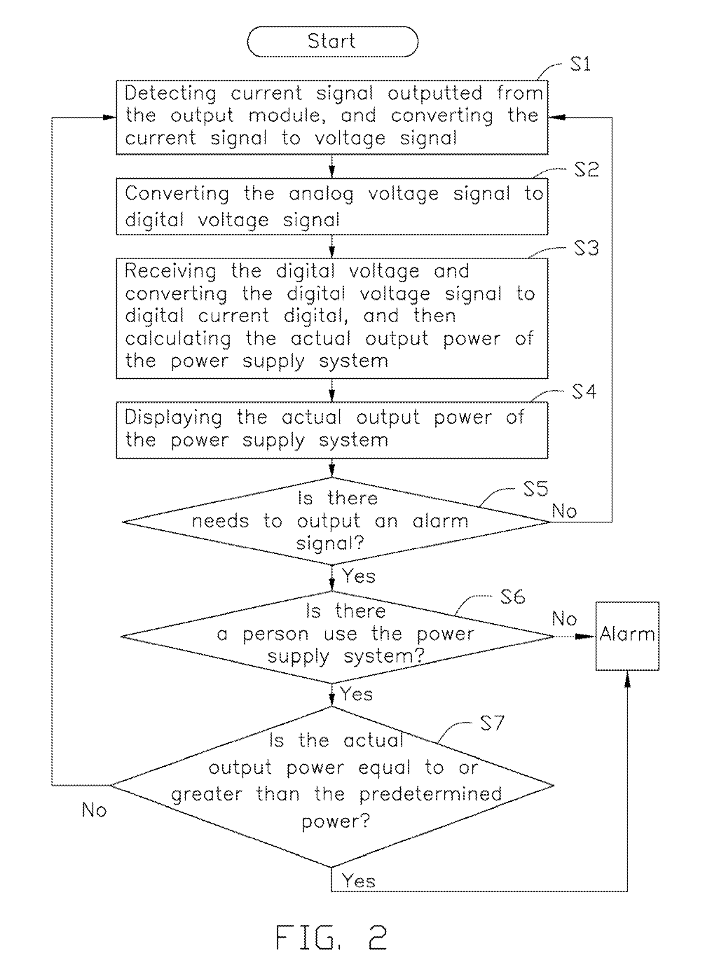

Referring to FIG. 2, an exemplary embodiment of a method for displaying power of a power supply system.

In step S1, the current detection module 20 detects current signal output from the output module 10, and converts the current signal to voltage signal.

In step S2, the analog-to-digital converter 30 converts the analog voltage signal to digital voltage signal.

In step S3, the control module 40 receives the digital voltage and convert the digital voltage signal to digital current digital, and then calculates the actual output power of the power supply system. In the present embodiment, the control module 40 calculates the actual output power of the power supply system 100 according to the rated voltages of the output module 10 and the digital current digital. The control module 40 determines if the predetermined power value is equal to or less than the rated power value of the power supply system 100, and if the predetermined power value is equal to the rated power of the power supply system 100.

In step S4, the display module 50 displays the predetermined power value and the actual output power of the power supply system 100.

In step S5, the control module 40 determines if there needs to be a warning signal. If there needs to be a warning signal, it flows to step S6. If there does not need to be a warning signal, it returns to S1.

In step S6, the control module 40 determines if there is a person using the power supply system. If there is no person using the power supply system, the power supply system outputs a warning signal. If there is a person using the power supply system, it flows to step S7.

In step S7, the control module 40 judges whether the actual output power is greater than the predetermined power value. If the actual output power is equal to or greater than the predetermined power value, the control module 40 outputs a warning signal. If the actual output power is less than the predetermined power value, it returns to S1.

It is to be further understood that even though numerous characteristics and advantages have been set forth in the foregoing description of embodiments, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

What is claimed is:

1. A detecting circuit for a power supply system, the circuit comprising:
a current detection module adapted for detecting current signal outputted from the power supply system and converting the current signal to analog voltage signal;
an analog-to-digital converter coupled to the current detection module for converting the analog voltage signal of the current detection module to digital voltage signal;
a control module coupled to the analog-to-digital converter for receiving the digital voltage signal outputted from the analog-to-digital converter and converting the digital voltage signal to digital current digital, and calculating an actual output power of the power supply; and
a display module coupled to the control module for displaying the actual output power of the power supply system.

2. The power supply system of claim 1, further comprising an alarm module coupled to the control module, the control module storing a predetermined power value of the power supply system, if the actual output power being equal to or greater than the predetermined power value, the alarm module outputting an alarm signal.

3. The power supply system of claim 2, wherein the display module displays the predetermined power value of the power supply system.

4. The power supply system of claim 2, wherein the predetermined power value is equal to the rated power of the power supply system.

5. A method for detecting an actual output power of a power supply system, the method comprising:
detecting current signal outputted from the power supply system and converting the current signal to voltage signal,
converting the analog voltage signal to digital voltage signal;
converting the digital voltage signal to digital current signal, and calculating the actual output power of the power supply system according to the digital current signal and a rated voltage signal of the power supply system; and
displaying the actual output power of the power supply system.

6. The method of claim of claim 5, further comprising determining if the actual output power is greater than a predetermined power value, if the actual output power being equal to or greater than the predetermined power value, the control module outputting an alarm signal.

7. The method of claim of claim 6, further comprising determining if there is a person using the power supply system, determining there is no person using the power supply system, the power supply system outputting a warning signal; and determining if there is a person using the power supply system, then judging whether the actual output power is greater than the predetermined power value.

8. The method of claim of claim 7, further comprising determining if there is a need to output a warning signal, determining it needs to be a warning signal, then judging whether there is a person using the power supply system.
